(19) United States
(12) Patent Application Publication
(10) Pub. No.: US 2006/0066194 A1
(43) Pub. Date: Mar. 30, 2006

(54) Spark plug

(76) Inventor: Robert Morin, Venice, CA (US)

Correspondence Address: JONES DAY, 555 SOUTH FLOWER STREET FIFTIETH FLOOR, LOS ANGELES, CA, 90071, US

(21) Appl. No.: 11/239,564

(22) Filed: Sep. 28, 2005

Related U.S. Application Data
(60) Provisional application No. 60/613,221, filed on Sep. 28, 2004.

(51) Int. Cl. H01T 13/00

(52) U.S. Cl. 313/118

(57) ABSTRACT

An improved spark plug of the type comprising a concentric arrangement of a center electrode, a multi-finned insulator comprised of zirconia surrounding the center electrode, and a metallic shell surrounding the insulator. The improvement comprises a cap and fire points attached to the end of the center electrode, the cap extending outward from the center electrode to the proximity of the base or an extension to the base so that the electrode extends a greater distance within the cylinder chamber, and apertures within the extended base.

### CROSS-REFERENCE TO RELATED APPLICATIONS

This application is a continuation of Provisional Patent Application Ser. No. 60/613,221, filed with the Patent and Trademark Office on Sep. 28, 2004.

### STATEMENT REGARDING FEDERALLY SPONSORED RESEARCH AND DEVELOPMENT

This invention was not developed as the result of any federally sponsored research and development.

### BACKGROUND OF THE INVENTION

The invention relates generally to internal combustion engines and more specifically to spark plugs for use therewith for igniting fuel-air mixtures in the cylinders of internal combustion engines.

A spark plug is a device one end of which extends into a cylinder of an internal combustion engine, exposing two electrodes with a gap therebetween within the cylinder. A compressed mixture of fuel vapor and air in a cylinder is ignited by establishing an electrical discharge across the gap between the two electrodes. The physical structure of a traditional spark plug is essentially a concentric arrangement of a cylindrical high-voltage center electrode, an insulator which surrounds and isolates the center electrode, and a threaded shell which surrounds the insulator. The threaded shell screws into a tapped hole that provides access to the interior of a cylinder. Typically, a metallic appendage fused to the rim of the shell and in close proximity to the center electrode acts as the ground electrode.

The first spark plug was invented by Etienne Lenior in France in 1885. Over the years improvements have been made by using stronger or more durable materials which allowed a somewhat longer life span. Present-day conventional spark plugs use a center electrode consisting of a nickel-chrome steel hollow sheath surrounding a copper-alloy center member.

The purpose of this structure is to protect the center electrode from the corrosive environment of the cylinder while at the same time enabling the rapid dissipation of heat from the tip of the center electrode to the cylinder head and to ceramic insulator. In more recent years, new materials like platinum, gold palladium, copper-core fine wire, tapered tip, and split-tip plugs have become available at considerable additional cost as compared with conventional ground-wire tip spark plugs. Today's premium high-performance plugs feature designs that provide greater durability, which in turn translates into better fuel economy and stronger long-term performance.

On the surface, a spark plug's job is simple: to create an electrical arc in the combustion chamber in order to ignite the air-fuel mixture. But in reality, it is a more complicated process than what first appears. First, it takes up to 40,000 volts supplied by the ignition coil) to create an arc that will jump from the center electrode to ground in the combustion chamber's pressurized environment. As the plug wears, the edges of the modern conventional electrode gradually round off, thereby increasing the voltage required to jump the gap. This is the main reason that spark plugs need to be replaced on a regular basis. As the voltage goes up, the chance of misfire fouling and pre-ignition increases, thereby causing rough idling, poor performance, reduced gas mileage, and increased emissions.

### BRIEF SUMMARY OF THE INVENTION

The invention is an improved spark plug of the type comprising a concentric arrangement of a center electrode, an insulator with enhanced fin type air cooled surface area surrounding the center electrode, and a metallic shell surrounding the insulator. The improvement comprises a cap and multiple contact points attached to the end of the center electrode, the cap extending outward from the center electrode to the proximity of the shell or an extension to the shell, and requires no indexing. The cap may be of a variety of shapes, the preferred shape being a fine wire multi-point star shape with opposing surfaces that are concave, convex, planar, or a combination.

Other improvements are provided by the elongated base portion of the plug which allows for deeper penetration of the center electrode into the cylinder chamber, and by the large open areas or holes within the base which permit the escape of gas that might otherwise be trapped within the extended base.

Yet another improvement is provided by the holes that are in certain of the cap designs.

### BRIEF DESCRIPTION OF THE DRAWINGS

FIG. 1 is a perspective view of a first embodiment of the improved spark plug.

FIG. 2 is a side view of a first embodiment of the improved spark plug.

FIG. 3 is a side view of the encircled portion of FIG. 2

FIG. 4 is a top view of a first embodiment of the improved spark plug shown in FIGS. 1 to 3.

FIG. 5 is an isolation view of only the base portion of the improved spark plug shown in FIGS. 1 to 4.

FIG. 6 is a cross-section of the base portion shown in FIG. 5, taken along line 6-6 in FIG. 5.

FIG. 7 is an exploded view of the improved spark plug shown in FIGS. 1 to 7.

FIG. 8 is a perspective view in isolation of only the upper part of the stem and the cap of the spark plug shown in FIGS. 1 to 7.

FIG. 9 is a side view of a second embodiment of the improved spark plug.

FIG. 10 is a top view of the spark plug shown in FIG. 9.

FIG. 11 is an exploded, perspective view of the upper portion of the spark plug shown in FIGS. 9 and 10.

FIG. 12 shows respective top and side view of alternative shapes for the spark plug cap.

FIG. 13 shows respective top and side view of alternative shapes for the spark plug cap.

### DETAILED DESCRIPTION OF THE PREFERRED EMBODIMENT

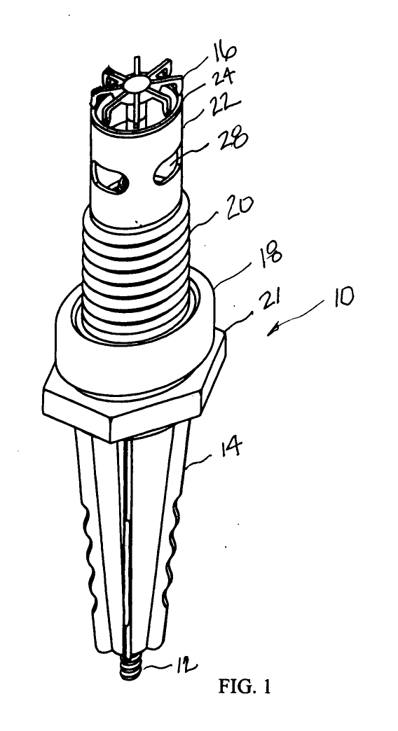

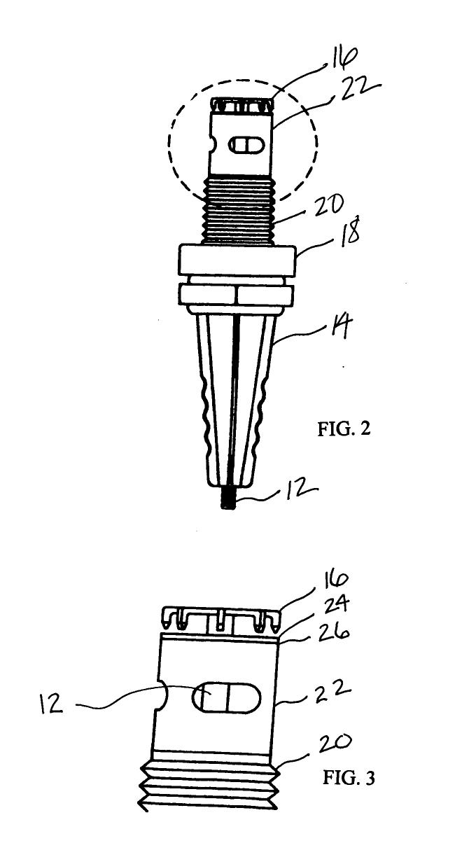

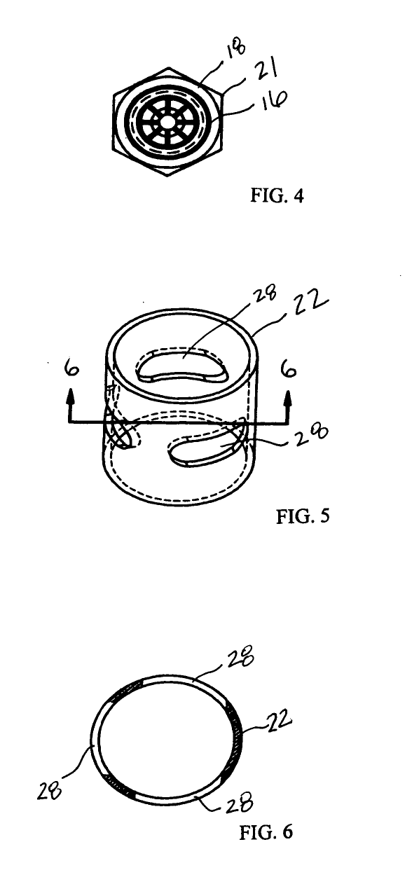

A first embodiment of the improved spark plug 10 is shown in FIG. 1 in which a center electrode 12 extends through the body 14 of the spark plug to the cap 16 which is attached to the end of the center electrode 12. The center electrode 12 and cap 16 may be fabricated either in one piece or separately and then fusion-welded together. The cap 16 may be made of the same material as the center electrode 12; such as titanium/silver (e.g. nickel-chrome steel). Preferably, the cap 16 should be made of a metal alloy augmented with platinum or other precious metals to avoid erosion as a result of the electrical discharge. The body 14 is substantially constructed of an insulating material so as to electrically isolates the center electrode 12 from the shell 18, a portion 20 of which is threaded for attachment to the engine block and a portion 21 of which is in the traditional form of a nut so that the plug can be inserted and removed by an appropriate tool. Extended above the shell 18 is a base 22.

Above the base 22 is a flat ring 24 made of a precious metal alloy may optionally be attached to the rim 26 of the shell. The flat ring 24 may be thick enough to be fusion-welded to the rim 26 or it may be a very thing layer deposited by well-known techniques on the rim 26 surface. The purpose of the flat ring 24 is to avoid erosion of the rim 26 and to enhance electrical discharges therefrom so as to improve conductivity.

The base 22 is shown in isolation in FIG. 5. As shown there, the base 22 has a series of elongated aperture or holes 28 around its periphery. As will be noted, the base 22 is significantly larger than in traditional spark plug design, resulting in the cap portion of the plug extending deeper into the engine's cylinder upon insertion. As seen in FIG. 6, the holes 28 preferably extend around a large portion of the base's circumference so as to provide a large area for gas to escape. While many different variations are possible, a base length of up to approximately 1 inch is shown.

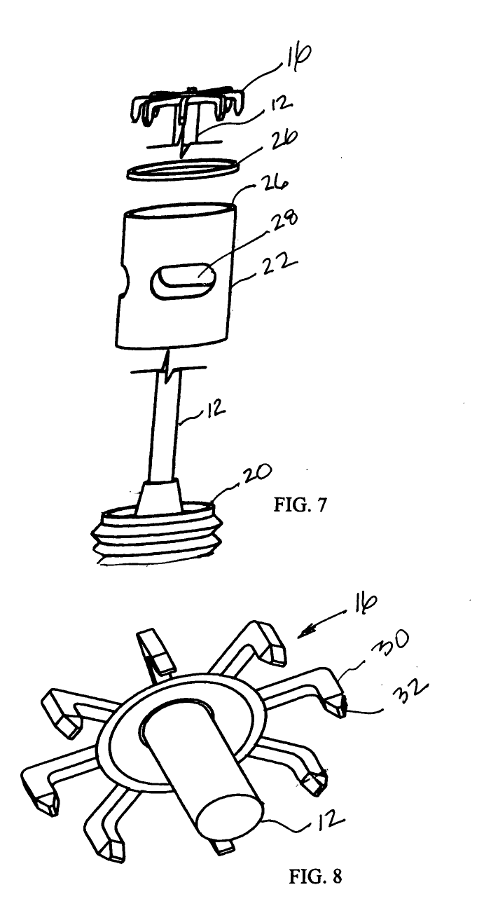

FIG. 7 shows the preferred spark plug in partial exploded view so that each of the major components can be seen, and particularly the flat ring 24.

A second embodiment of the improved spark plug is shown in FIG. 8, in which the cap 16 comprises a number of legs 30 extending from the center electrode 12, and each of the legs 30 has a downwardly facing, sharpened tip 32 that is preferably constructed of platinum or gold palladium.

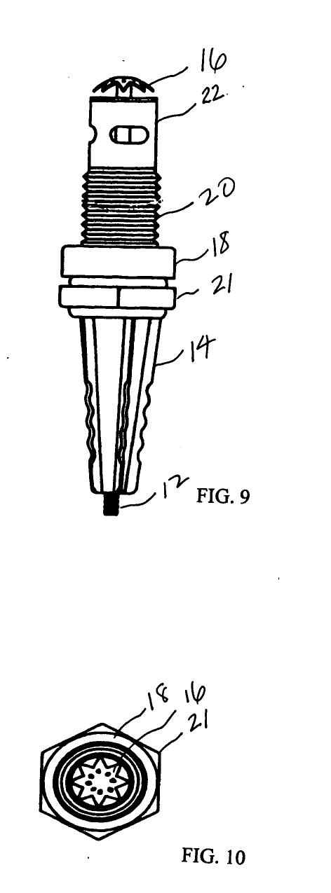

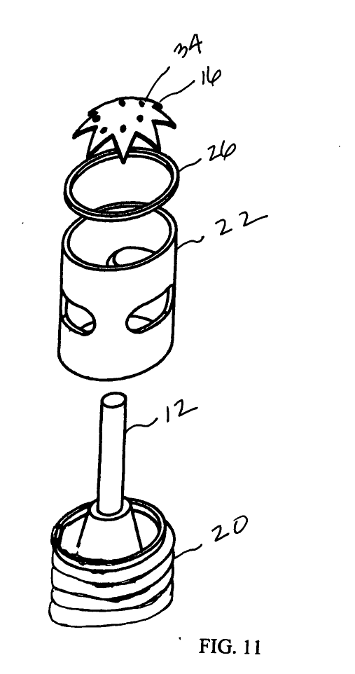

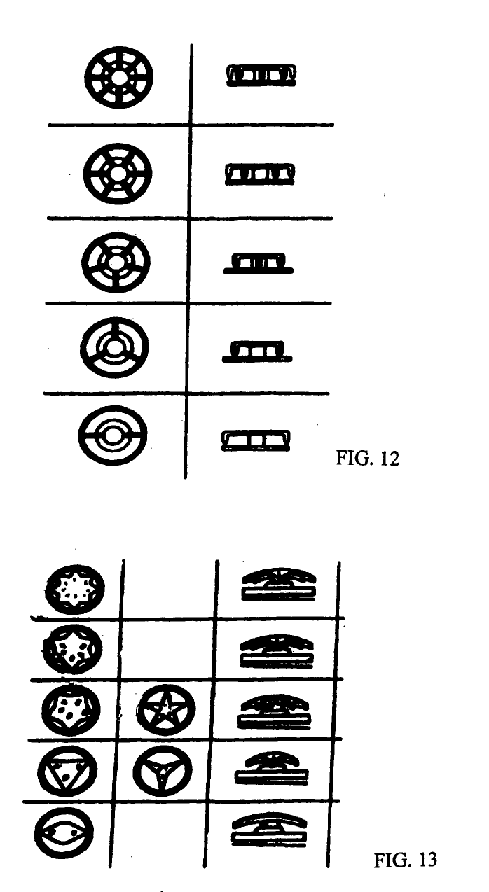

The caps 16 can have a variety of shapes. The preferable shapes are the star shapes shown in FIGS. 9, 10 11 and 13. FIG. 12 shows vearious fine wire caps with the number of points varying from 2 to 8. As seen in FIG. 11, the star-shaped cap 16 shown there has a series of small holes 34 which extend therethrough to also aid in combustion of the gas/air mixture within the cylinder.

It is desirable for reasons related to combustion efficiency that a cap be symmetrical with respect to a plurality of planes containing the center electrode and that the angular spacing between adjacent planes of symmetry be the same. The star-shaped caps shown in FIG. 12 illustrate this symmetry. Convex caps, concave caps, and planar caps can also be used.

The improved spark plug described herein is designed to reduce emissions and make the combustion process more efficient, thereby extending the spark plug's service life. With the center electrode extended further into the combustion chamber, this improved spark plug provides the means for more effectively accomplishing the combustion process by initiating the process further into the fuel-air mixture and to provide more surface area to be cooled by incoming gas, as well as increase flame front-kernel without obstruction from a ground wire.

Although preferred embodiments have been shown and described, the disclosed invention and the protection afforded by this patent are not limited thereto, but are of the full scope of the following claims, and equivalents thereto.

What is claimed is:

1. A spark plug comprising:
a) a body having an insulator;
b) a central portion on said body;
c) a portion of said central portion comprising exterior threads;
d) an electrically conducive, substantially elongated base extending above said exterior threads;
e) an electrode extending through said body and said base and extending a portion thereabove;
f) an electrically conducive cap attached to said electrode; and
g) one or more apertures in said base.

2. The invention of claim 1 further comprising said cap having a substantially star-shaped configuration, and having a plurality of holes therein.
